(19) United States
(12) Patent Application Publication
(10) Pub. No.: US 2012/0255237 A1
(43) Pub. Date: Oct. 11, 2012

(54) COOL CUTTING POLYCRYSTALLINE DIAMOND CUTTING ELEMENT

(76) Inventor: Robert Frushour, Ann Arbor, MI (US)

(21) Appl. No.: 13/208,491

(22) Filed: Aug. 12, 2011

Related U.S. Application Data
(60) Provisional application No. 61/473,227, filed on Apr. 8, 2011.

(51) Int. Cl. B24D 3/10; B01J 3/06

(52) U.S. Cl. 51/309; 51/307

(57) ABSTRACT

A PDC cutting element is described with a high abrasion thermally stable cutting edge that is supported by a diamond matrix which presents a non-planar wear surface to the rock interface. The non-planar wear surface of the supporting layer dramatically reduces the amount of heat generated at the PDC rock interface and provides rapid cutting with less weight on the bit for deep hole drilling applications.

### CROSS REFERENCE TO CO-PENDING APPLICATION

This application claims priority benefit of the U.S. Provisional Application Ser. No. 61/473,227 filed on Apr. 8, 2011 in the name of R. Frushour, the entire contents which are incorporated herein by reference.

### BACKGROUND OF THE INVENTION

1. Field of the Invention

This invention relates to PDC cutting elements used in deep hole drilling for oil and gas that require high abrasion and impact resistance.

2. Background of the Invention

State of the art PDC cutters used in drill bits employ the use of a diamond layer with a thermally stable cutting edge that is presented to the rock surface during deep hole drilling. There are numerous patents that describe methods by which a PDC can be fabricated with a thermally stable diamond cutting edge. Examples are given in U.S. Pat. No. 4,224,380 to Bovenkerk and similar U.S. Pat. Nos. 6,878,447, 6,861,137, 6,361,098, 6,797,326, 6,739,214, 6,592,985, 6,589,640, 6,562,462 and 6,544,308 to Griffin both of which teach creating a thermally stable cutting edge by partially leaching the diamond layer of a PDC to remove the catalyst sintering aid. A different approach is shown in U.S. Pat. No. 5,127,923 to Bunting whereby a presintered diamond layer is leached to remove essentially all of the catalyst and then attached to a substrate in a second high-pressure/high-temperature step. In this method, catalyst metal, typically cobalt, sweeps into the diamond layer from the substrate and forms a strong bond between the diamond layer and the substrate. The catalyst metal is prevented from infiltrating the entire diamond table thus providing a thermally stable portion of the diamond body next to the cutting edge.

As long as the thermally stable portion of the diamond layer is the only surface that is in contact with the rock, cutting proceeds rapidly and the projected life span of the cutter is satisfactory. However as soon as the cutter wears past the thermally stable portion of the diamond layer things begin to rapidly deteriorate. That portion of the diamond table which is not thermally stable begins to rub on the rock surface and generates heat due to friction. This causes the temperature to rise and catastrophic failure of the diamond table occurs as a result of reverse catalytic action and the difference in thermal expansion between the diamond and the catalyst used as a sintering aid. Additionally, the friction generated requires more force in order to rotate the drill bit. Often when analyzing the cracking and spalling of the diamond table it appears that the PDC cutter is failing due to poor impact resistance. As a result, many solutions for improving the impact resistance of PDC cutters have been proposed. One method commonly known in the art to increase the size of the diamond crystals in the diamond table of the PDC. Unfortunately this and other solutions relate to the impact resistance of cutters at low temperature and, in general, have been obtained at the expense of abrasion resistance. PDC cutter failure in drill bits with current bit designs and drilling techniques is, in most instances, due to loss of abrasion resistance at the high temperatures generated while drilling and not do to impact failure. This loss of abrasion resistance at high temperature that has been addressed by Bovenkerk and others does not protect the cutter once it wears past the thermally stable portion of the diamond table. An approach to providing a free cutting PDC is shown in U.S. Pat. Nos. 6,852,414 and 7,070,635 to Frushour by constructing diamond layer with nodules that provide an irregular cutting edge. This PDC cutter is manufactured with one continuous diamond layer containing aggregated diamond clumps and then the outer portion of the diamond layer can be leached to make it thermally table. The result, however, is not ideal. This is because, for leached cutters, the nodular cutting edge wears more rapidly than a cutting edge which has been created with a uniform matrix of diamond crystals. This may be a result of non-uniform or incomplete leaching of a nodular layer that been separated into areas with different densities of diamond crystals. Thus, although providing a diamond layer which is partially thermally stable is an improvement, further improvement to reduce the heat generated while drilling is needed to protect the overall integrity of the PDC cutting element.

### SUMMARY

The instant invention is to divide the polycrystalline diamond table into two distinct layers with different densities of diamond crystals. The outer most layer is that portion of the cutter which does the actual cutting of the rock. The second layer has a nodular structure that provides a non-uniform wear surface, supports the diamond cutting table and creates a strong bond between the cutting table and the cobalt cemented tungsten carbide substrate. One polycrystalline diamond construction includes a first surface of a uniform first matrix of sintered together diamond grains, a second supporting matrix of diamond adjacent to the first surface and containing a dispersion of agglomerated fine diamond crystals randomly distributed throughout its body wherein the average diameter of the agglomerations is significantly larger than the single crystal diamond used in the matrix and a third surface consisting of a supporting substrate attached to the polycrystalline diamond layer.

The agglomerated fine diamond crystals can be pre-sintered with a catalyst sintering aid at high-pressure and high-temperature.

The pre-sintered agglomerations can be leached or otherwise treated to render the catalyst sintering aid inactive.

In one aspect, the second matrix is made up of diamond crystals whose average diameter is at least 2.5 times larger than the diameter of the diamond component particles of the aggregations.

In another aspect, the average diameter of the aggregations is larger than 100 microns. The volume of the aggregations can be between 10 percent and 90 percent of the total volume of the second matrix of diamond particles.

The first surface can be a thickness which is less than the thickness of the second diamond matrix. The first surface can be a thickness less than about 0.5 mm. The second diamond matrix can be a thickness greater than about 0.5 mm.

The substrate can be composed of two phases, one of which contains agglomerated fine particles distributed throughout a bulk matrix of similar material. The substrate can be composed of cobalt cemented tungsten carbide, where the tungsten carbide is a matrix of a uniform mix of grains with agglomerated finer particles of tungsten carbide distributed throughout the matrix.

In one aspect, the aggregations comprise diamond particles with an average diameter less than 1 micron and the matrix diamond has a average particle size greater than 10 microns. The agglomerated diamond layer can be partially leached of catalytic material or the catalyst is otherwise rendered inactive. The first surface can be formed of diamond particles having an average grain size of about 15 microns. The second surface is formed of agglomerated grains between about 250 microns and about 600 microns in size mixed with 25 micron sized diamond powder, and a cobalt cemented tungsten carbine substrate joined to the first and second layers by sintering at high pressure and high temperature.

A method for making a polycrystalline diamond construction is disclosed which includes the steps of:
loading a uniform mix of diamond grains into a suitable container;
loading a mixture of agglomerated fine diamond grains and non-agglomerated diamond grains with substantially larger grain size than that contained in the agglomerations on top of the first layer;
placing a substrate into the container; and
subjecting the mixture and substrate to high-pressure and high-temperature conditions.

The first surface can be made in a separate high-pressure/high-temperature manufacturing step.

In another aspect, the method includes the step of making the first surface in a separate high-pressure/high-temperature manufacturing step and leaching the first surface to remove the catalyst material or otherwise making the catalyst inactive.

### BRIEF DESCRIPTION OF THE DRAWINGS

The various features, advantages and other uses of the cool cutting polycrystalline diamond cutting element will be come more apparent by referring to the following detailed description and drawing in which:

FIG. 1 shows the cutting edge and wear surface of a PDC cutting element made by prior art techniques; and

FIG. 2 shows the cutting edge and wear surface of a PDC made according to of this invention.

### DETAILED DESCRIPTION

This invention relates to that portion of the PDC cutter which directly supports the cutting edge of the diamond table. This is the layer located between the thermally stable diamond layer at the working surface of the cutting edge and the supporting substrate for the diamond which is usually composed of cobalt cemented tungsten carbide. Normally this portion of the cutter is a uniform matrix polycrystalline diamond which contains the metal catalyst in the interstices between the diamond crystals from the original sintering operation during the initial manufacture of the cutter.

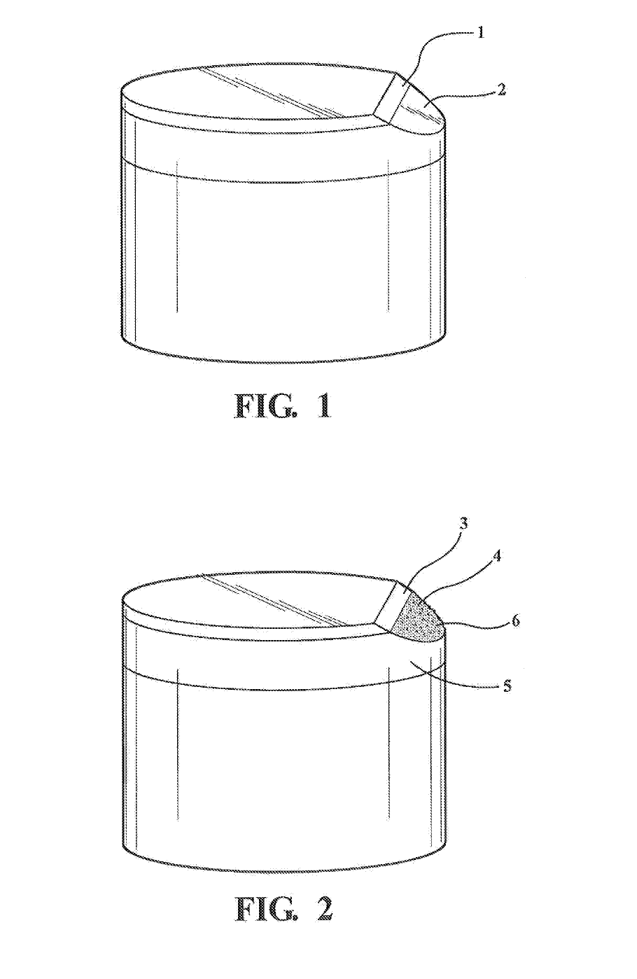

FIG. 1 shows the wear surface 2 of a diamond layer that is adjacent to the cutting edge 1 of a PDC made by prior art technique. The wear surface 2 is flat which results in intimate contact between the diamond and the work material. This relatively large surface area in contact with rock while drilling or in contact with other work surfaces creates high temperatures at the interface.

FIG. 2 shows the wear surface 4 of a diamond body 5 which supports an adjacent thermally stable layer that provides the cutting edge 3 of the PDC according to this invention. The wear surface 4 has nodules 6 which protrude from the bulk matrix of the diamond body 5.

The second supporting layer shown in FIG. 2 is constructed of a dispersion of areas of aggregated very fine diamond particles throughout a continuous matrix of larger diamond crystals the whole of which is sintered with the aid of a catalyst. The agglomerated areas of fine diamond particles may, but not necessarily, be pre-sintered prior to inclusion into this second supporting layer. The layer of polycrystalline diamond may be as sintered and retain the catalyst sintering aid or the layer may have some or all of the metal catalyst removed or altered to render it thermally stable.

The pre-sintered agglomerations are leached or otherwise treated to render the catalyst sintering aid inactive. The diamond particles in the agglomerations may have an average diameter of less than one micron and the matrix diamond may have an average particle size greater than 10 microns. The average diameter of aggregations may be larger than 100 microns. The volume of the aggregations is between 10% and 90% of the total volume of the second matrix of diamond particles.

The first surface may have a thickness of less than 0.5 mm. The second diamond matrix may have a thickness greater than 0.5 mm.

The substrate may be formed of two phases one of which contains a agglomerated fine diamond particles distributed through a bulk matrix of similar materials. The substrate may be formed of cobalt cement tungsten carbide, where the tungsten carbide is a matrix of a uniform mix of grains with agglomerated finer particles of tungsten carbide distributed through out the matrix.

Initially, while drilling, only the thermally stable cutting edge of a PDC is in contact with rock. Eventually, however, the diamond table of a conventional PDC wears past the thermally stable cutting edge and that portion of the diamond layer which is not thermally stable comes in contact with the rock. When a PDC made according this invention wears past the thermally stable cutting edge, a second layer of diamond is exposed which generates a non planar surface that results in less friction thus generating much less heat. The non planar wear surface develops from the wear properties intrinsic in a diamond body containing embedded areas of fine densely packed diamond crystals surrounded by a uniform matrix of larger crystals. A direct result is less overall thermal damage to the PDC cutter thereby increasing its life span dramatically. Additional benefits are more rapid rock penetration with less weight on bit. The improvement using a PDC with a cutting edge constructed of a uniform matrix of diamond verses that with a non-uniform matrix may alternately be due to enhanced diamond to diamond bonding throughout the relatively thin cutting edge. Alternately, it may be do to more thorough leaching of a thermally stable diamond layer that has a uniform matrix of interstices. Whatever the mechanism, a thin cutting edge of nonaggregated diamond supported by the aggregate diamond layer gives a surprising improvement in overall cutting performance.

### Example 1

100 milligrams of a mixture of diamond with an average grain size of 15 microns is 3 thoroughly cleaned and fired in a hydrogen furnace to 900 degrees centigrade. This mixture is placed into the bottom of a 0.5 inch diameter molybdenum cup. A 1 gram sample of 0.4 micron diamond powder is processed and sieved to obtain blocky agglomerated grains between 250 microns and 600 microns in size. A 75 milligram sample of the sieved blocky grains is then mixed with 300 milligrams of 25 micron diamond powder. This mixture is then placed on top of the diamond already in the cup. Finally, a cobalt cemented tungsten carbide substrate is placed into the cup on top of the diamond layers. This assembly is then loaded into a high pressure cell and pressed to 55 K-bars for 10 minutes at 1450 degrees Centigrade. After cutting the power to the cell and allowing the cell to cool at high pressure for one minute, the pressure is released. The PDC composite body is removed from the other cell components and lapped and ground to final dimensions.

The abrasion resistance measured after machining Barre granite is significantly higher and the noise and vibration of the machining operation is significantly lower than that for PDC made by prior art methods.

What is claimed is:

1. A polycrystalline diamond construction comprising:
a first surface of a uniform first matrix of sintered together diamond grains;
a second supporting matrix of diamond adjacent to the first surface containing a dispersion of agglomerated fine diamond crystals randomly distributed throughout its body wherein the average diameter of the agglomerations is significantly larger than the single crystal diamond used in the matrix; and
a third surface consisting of a supporting substrate attached to the polycrystalline diamond layer.

2. The construction of claim 1 wherein the agglomerated fine diamond crystals are pre-sintered with a catalyst sintering aid at high-pressure and high-temperature.

3. The construction of claim 2 wherein the pre-sintered agglomerations are leached or otherwise treated to render the catalyst sintering aid inactive.

4. The construction of claim 1 wherein the agglomerations are bonded with a non-catalytic sintering aid.

5. The construction of claim 1 wherein the second matrix is made up of diamond crystals whose average diameter is at least 2.5 times larger than the diameter of the diamond component particles of the aggregations.

6. The construction of claim 1 wherein the average diameter of the aggregations in the second matrix is at least 2.5 times larger than average size of the individual diamond particles of the first matrix.

7. The construction of claim 1 wherein the average diameter of the aggregations is larger than 100 microns.

8. The construction of claim 1 wherein the volume of the aggregations is between 10 percent and 90 percent of the total volume of the second matrix of diamond particles.

9. The construction of claim 1 whereby the first surface has a thickness which is less than the thickness of the second diamond matrix.

10. The construction of claim 1 wherein the first surface has a thickness less than about 0.5 mm.

11. The construction of claim 1 wherein the second diamond matrix has a thickness greater than about 0.5 mm.

12. The construction of claim 1 wherein the substrate is composed of two phases, one of which contains agglomerated fine particles distributed throughout a bulk matrix of similar material of larger particle size.

13. The construction of claim 1 wherein the substrate is composed of cobalt cemented tungsten carbide and the tungsten carbide is a matrix of a uniform mix of grains with agglomerated finer particles of tungsten carbide distributed throughout the matrix.

14. The construction of claim 1 wherein the first surface is made thermally stable by leaching out substantially all of the catalyst material used to fabricate the diamond construction or otherwise render the catalyst material inactive.

15. The construction of claim 1 wherein the aggregations comprise diamond particles with an average diameter less than 1 micron and the matrix diamond has an average particle size greater than 10 microns.

16. The construction of claim 15 wherein the agglomerated diamond layer is partially leached of catalytic material or the catalyst is otherwise rendered inactive.

17. The construction of claim 1 wherein the first surface is formed of diamond particles having an average grain size of about 15 microns;
the second surface is formed of agglomerated grains between about 250 microns and about 600 microns in size mixed with 25 micron sized diamond powder; and
a cobalt cemented tungsten carbine substrate joined to the first and second layers by sintering at high pressure and high temperature.

18. A method for making a polycrystalline diamond construction including the steps of:
loading a uniform mix of diamond grains into a suitable container;
loading a mixture of agglomerated fine diamond grains and non-agglomerated diamond grains with substantially larger grain size than that contained in the agglomerations on top of the first layer;
placing a substrate into the container; and
subjecting the mixture and substrate to high-pressure and high-temperature conditions.

19. A method for making the polycrystalline diamond construction of claim 18 by making the first surface in a separate high-pressure/high-temperature manufacturing step.

20. A method for making the polycrystalline diamond construction of claim 18 by making the first surface in a separate high-pressure/high-temperature manufacturing step and leaching the first surface to remove the catalyst material or otherwise making the catalyst inactive.
